(19) United States
(12) Patent Application Publication
(10) Pub. No.: US 2009/0083294 A1
(43) Pub. Date: Mar. 26, 2009

(54) EFFICIENT XML SCHEMA VALIDATION MECHANISM FOR SIMILAR XML DOCUMENTS

(76) Inventors: Shudi Gao, Richmond Hill (CA); Michael Rafael Glavassevich, Markham (CA); Neil Graham, Toronto (CA); Glenn Allen Marcy, Dublin, OH (US); Yuhichi Nakamura, Yokohama-shi (JP); Toyotaro Suzumura, Tokyo (JP); Toshiro Takase, Yamato-shi (JP); Michiaki Tatsubori, Yokohama-shi (JP)

Correspondence Address: IBM CORP (YA);C/O YEE & ASSOCIATES PC, P.O. BOX 802333, DALLAS, TX, 75380, US

(21) Appl. No.: 11/861,063

(22) Filed: Sep. 25, 2007

(51) Int. Cl. G06F 17/30

(52) U.S. Cl. 707/100; 707/E17.122

(57) ABSTRACT

The illustrative embodiments described herein provide for a method for validating a target document written in a structured language against a schema for the structured language. A record of document fragments that have been previously validated against the schema is maintained. The target document is compared to the document fragments to identify portions of the target document that are schematically identical to corresponding document fragments. Validation is omitted for at least one of the portions of the target document that are schematically identical to the corresponding document fragments when validating the target document.

### BACKGROUND OF THE INVENTION

1. Field of the Invention

The present invention relates generally to an improved data processing system and in particular to a method and apparatus for validating code. More particularly, the present invention relates to a computer implemented method, apparatus, and a computer usable program product for validating an XML (extensible markup language) document against an XML schema.

2. Description of the Related Art

Many web pages on the Internet today are written in structured languages. The structured language is a programming language when the program may be broken down into blocks or procedures, which can be written without detailed knowledge of the interworkings of other blocks, thus allowing a top-down design approach. Examples of structured languages include extensible markup language (XML), hypertext markup language, extended hypertext markup language and many others. Additionally, structured languages include languages that are based on these other languages. For example, languages such as RSS, math ML, graph ML, scaleable vector graphics, music XML, and others. Thus, structured languages are a very common source of computer programming.

Documents drafted in markup language or a structured language are often validated in order to ensure that the document is free of errors and will perform according to its intended use. When validating a structured language document, often the document is compared to a particular schema. For example, an XML document that complies with a particular schema, in addition to be well formed, is said to be valid. In another example, an XML schema is a description of an XML document typically expressed in the terms of constraints and structure of contents of documents of that type, above and beyond the basic constraints composed by XML itself. A number of standard and proprietary XML schema languages exist for the purpose of formally expressing such schemas. Some of these languages are XML based themselves. Examples of schemas for XML include document type definition (DTD), XML schema definition (XSD), W3C XML schema (WXS), RELAX NG, document schema description languages (DSDL), and others.

The process of validating structured language documents can take a considerable amount of time, particularly, when many documents are to be validated or when a particular document is very long. Thus, efforts have been made to improve the process of validating structured language documents. In the case of XML, documents are parsed and compared against a particular schema. Most traditional XML parsers such as the Apache Xerces-J and Xerces-C parsers scan and validate XML documents in two distinct phases. In Xerces-C, the scanner examines each tag name and item of text context for well-formedness, then presents each tag name and item of text context to validation componentry if validation is enabled for the document in question. The scanner then presents the data to an application program interface (API) generator, if the validation component returns an indication that the data is valid. In Xerces-J, a pipeline architecture used for a validation component may optionally be plugged between the scanning component and the API generator. However, in neither of these architectures is any knowledge of the grammar against which the document is being validated used to assist scanning of the tokens comprising the document. Additionally, similarities between documents processed by a given parser are not used to speed up parsing.

### SUMMARY OF THE INVENTION

The illustrative embodiments described herein provide for a method for validating a target document written in a structured language against a schema for the structured language. A record of document fragments that have been previously validated against the schema is maintained. The target document is compared to the document fragments to identify portions of the target document that are schematically identical to corresponding document fragments. Validation is omitted for at least one of the portions of the target document that are schematically identical to the corresponding document fragments when validating the target document.

In another illustrative example, the method further includes adding to the record of document fragments, after successful validation of the target document, at least one portion of the target document that was not schematically identical to any document fragments in the record of document fragments.

Another illustrative example, provides for a method for validating a target document written in a structured language against a schema for the structured language. A first part of the target document is compared to a document fragment, wherein the document fragment was previously validated against the schema. Responsive to the first part of the target document matching the document fragment, validation of the first part of the target document is omitted.

In another illustrative example, the method further includes, responsive to the first part of the target document failing to match the document fragment, validating the first part of the target document.

In another illustrative example, the target document comprises a plurality of additional document fragments, wherein each of the plurality of additional document fragments were previously validated against the schema. In this case wherein the method further includes, responsive to the first part of the target document matching any of the plurality of additional document fragments, omitting validation of the first part of the target document. Responsive to the first part of the target document failing to match both the document fragment and all of the plurality of additional document fragments, the first part of the target document is validated.

In another illustrative example, the first part of the target document comprises less than all of the target document.

In another illustrative example, the document fragment is a second part of the target document.

In another illustrative example, the method further includes generating the document fragment by successfully validating the second part of the target document against the schema and then storing the second part of the target document as the document fragment.

In another illustrative example, the method further includes parsing the target document into the first part of the target document. In this case, the first part of the target document is a scanner event. The scanner event is transmitted to an event queue.

In another illustrative example, the scanner event comprises at least one of a start tag, a text content, a white space, and an end tag.

In another illustrative example, the method further includes transmitting the scanner event to a virtual machine and performing a comparison in the virtual machine.

In another illustrative example, the method further includes requesting an automaton processor to create a new state node and transmitting at least one object to the automaton processor.

In another illustrative example, the at least object is selected from the group consisting of a reference to an associated instruction in a byte code, a byte array, a scanner context, and a virtual machine context.

In another illustrative example, the scanner context comprises at least one of a namespace, an element stack, and a symbol table.

In another illustrative example, the virtual machine context enables the virtual machine to validate a corresponding portion of a subsequent part of the target document.

In another illustrative example, the target document comprises an extensible markup language document and wherein the schema comprises an extensible markup language schema.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which illustrative embodiments may be implemented;

FIG. 2 is a block diagram of a data processing system in which illustrative embodiments may be implemented;

FIG. 3 is a block diagram illustrating an overview of a validation mechanism for validating a structured language document in accordance with an illustrative embodiment;

FIG. 4 is a block diagram of an exemplary validation engine in accordance with an illustrative embodiment;

FIG. 5 is a block diagram illustrating an exemplary automaton in accordance with an illustrative embodiment;

FIG. 6 is a block diagram illustrating processing of a new structured language document using an automaton in accordance with an illustrative embodiment;

FIG. 7 illustrates an exemplary XML schema in accordance with an illustrative embodiment;

FIG. 8 illustrates a first XML document fragment to be compared to the XML schema shown in FIG. 7 in accordance with an illustrative embodiment;

FIG. 9 is a block diagram illustrating an exemplary automaton representing the first XML document fragment shown in FIG. 8 in accordance with an illustrative embodiment;

FIG. 10 illustrates a second XML document fragment to be compared to the XML schema shown in FIG. 7 in accordance with an illustrative embodiment;

FIG. 11 is a block diagram illustrating an exemplary automaton representing the second XML document fragment shown in FIG. 10 in accordance with an illustrative embodiment;

FIG. 12 is a flowchart illustrating an exemplary process for validating an XML document in accordance with an illustrative embodiment;

FIG. 13 is a flowchart illustrating an exemplary operation of a scanner in an exemplary validation engine in accordance with an illustrative embodiment;

FIG. 14 is a flowchart illustrating an exemplary operation of a virtual machine of a validation engine in accordance with an illustrative embodiment;

FIG. 15 is a flowchart illustrating an exemplary operation of an automaton processor of a validation engine in accordance with an illustrative embodiment;

FIG. 16 is a flowchart illustrating an exemplary method of partial validation of a target document in accordance with an illustrative embodiment; and

FIG. 17 is a flowchart illustrating an exemplary method of partial validation of a target document in accordance with an illustrative embodiment.

### DETAILED DESCRIPTION OF THE PREFERRED EMBODIMENT

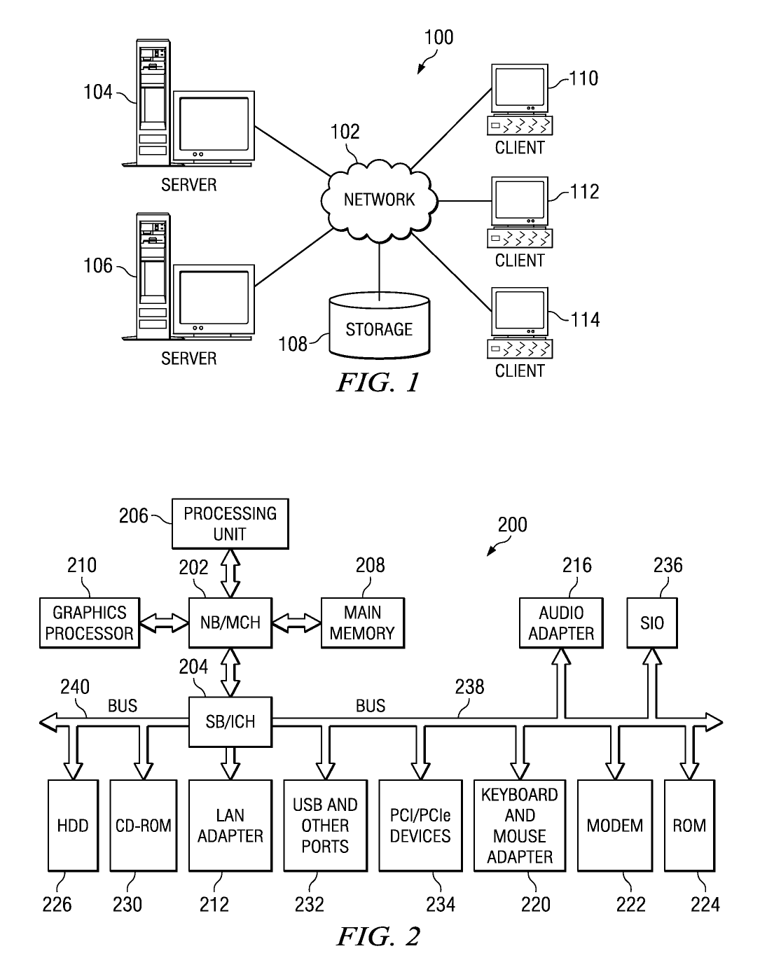

With reference now to the figures and in particular with reference to FIG. 1, a pictorial representation of a data processing system is shown in which illustrative embodiments may be implemented. Computer 100 includes system unit 102, video display terminal 104, keyboard 106, storage devices 108, which may include floppy drives and other types of permanent and removable storage media, and mouse 110. Additional input devices may be included with personal computer 100. Examples of additional input devices could include, for example, a joystick, a touchpad, a touch screen, a trackball, and a microphone.

Computer 100 may be any suitable computer, such as an IBM® eServer™ computer or IntelliStation® computer, which are products of International Business Machines Corporation, located in Armonk, N.Y. Although the depicted representation shows a personal computer, other embodiments may be implemented in other types of data processing systems. For example, other embodiments may be implemented in a network computer. Computer 100 also preferably includes a graphical user interface (GUI) that may be implemented by means of systems software residing in computer readable media in operation within computer 100.

Next, FIG. 2 depicts a block diagram of a data processing system in which illustrative embodiments may be implemented. Data processing system 200 is an example of a computer, such as computer 100 in FIG. 1, in which code or instructions implementing the processes of the illustrative embodiments may be located.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204, audio adapter 216, keyboard and mouse adapter 220, modem 222, read only memory (ROM) 224, universal serial bus (USB) and other ports 232. PCI/PCIe devices 234 are coupled to south bridge and I/O controller hub 204 through bus 238. Hard disk drive (HDD) 226 and CD-ROM 230 are coupled to south bridge and I/O controller hub 204 through bus 240.

PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206. This operating system coordinates and controls various components within data processing system 200 in FIG. 2. The operating system may be a commercially available operating system, such as Microsoft® Windows® XP. (Microsoft® and Windows® are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226. These instructions and may be loaded into main memory 208 for execution by processing unit 206. The processes of the illustrative embodiments may be performed by processing unit 206 using computer implemented instructions, which may be located in a memory. An example of a memory is main memory 208, read only memory 224, or in one or more peripheral devices.

The hardware shown in FIG. 1 and FIG. 2 may vary depending on the implementation of the illustrated embodiments. Other internal hardware or peripheral devices, such as flash memory, equivalent non-volatile memory, or optical disk drives and the like, may be used in addition to or in place of the hardware depicted in FIG. 1 and FIG. 2. Additionally, the processes of the illustrative embodiments may be applied to a multiprocessor data processing system.

The systems and components shown in FIG. 2 can be varied from the illustrative examples shown. In some illustrative examples, data processing system 200 may be a personal digital assistant (PDA). A personal digital assistant generally is configured with flash memory to provide a non-volatile memory for storing operating system files and/or user-generated data. Additionally, data processing system 200 can be a tablet computer, laptop computer, or telephone device.

Other components shown in FIG. 2 can be varied from the illustrative examples shown. For example, a bus system may be comprised of one or more buses, such as a system bus, an I/O bus, and a PCI bus. Of course the bus system may be implemented using any suitable type of communications fabric or architecture that provides for a transfer of data between different components or devices attached to the fabric or architecture. Additionally, a communications unit may include one or more devices used to transmit and receive data, such as a modem or a network adapter. Further, a memory may be, for example, main memory 208 or a cache such as found in north bridge and memory controller hub 202. Also, a processing unit may include one or more processors or CPUs.

The depicted examples in FIG. 1 and FIG. 2 are not meant to imply architectural limitations. In addition, the illustrative embodiments provide for a computer implemented method, apparatus, and computer usable program code for compiling source code and for executing code. The methods described with respect to the depicted embodiments may be performed in a data processing system, such as data processing system 100 shown in FIG. 1 or data processing system 200 shown in FIG. 2.

The illustrative embodiments described herein provide for a method, apparatus, and computer usable program product for validating an XML (extensible markup language) document against an XML schema. However, the methods and devices described herein can be applied to other schema languages and other structured language documents. Examples of other schema languages to which the methods and devices described herein can be applied include DTD and RELAX NG, though many other structured language schemas can be used with the methods and devices described herein.

For example, an illustrative embodiment provides a method for validating a target document written in a structured language against a schema for the structured language. According to this illustrative method, a record of document fragments that have been previously validated against the schema is maintained. The document fragment is a portion of a document written in a structured language. The method also includes comparing the target document to the document fragments to identify portions of the target document that are schematically identical to corresponding document fragments. The term schematically identical means sufficiently similar in structure to a known fragment to be confident that if the known fragment is valid according to the schema, then the portion is also valid according to the schema, even if certain informational content is different. The exemplary method also includes omitting validation for at least one of the portions of the target document that are schematically identical to the corresponding document fragments when validating the target document.

After successful validation of the target document, at least one portion of the target document that was not schematically identical to the corresponding document fragments are added to the record of the document fragments that is maintained. Thus, in this illustrative example, only those portions of a structured language document that have not previously been validated are validated. Those portions of the structured language document that have already been validated are not validated. In this way, a more efficient schema for validating target documents is presented.

Another illustrative method for validating a target document written in a structured language against a schema for a structured language is to first compare a first part of the target document to a document fragment. The document fragment was previously validated against the schema. Then, responsive to the first part of the target document matching the document fragment, validation of the first part of the target document is omitted. However, if the first part of the target document fails to match the target document, then the first part of the target document is instead validated.

Generally, the target document can include a great number of additional document fragments. Each of the additional document fragments were previously validated against the schema. In this case, an exemplary method includes, responsive to the first part of the target document matching any of the plurality of additional document fragments, omitting validation of the first part of the target document. However, responsive to the first part of the target document failing to match both the document fragment and also failing to match any of the plurality of additional document fragments, the first part of the target document is validated.

These exemplary methods can be modified or expanded. For example, in an illustrative example, the first part of the target document is less than all of the target document. In another illustrative embodiment, the document fragment is a second part of the target document. In this illustrative embodiment, as a particular document is parsed and validated, those parts of the document that are similar to the previously validated parts are not further validated.

Thus, the illustrative embodiments described herein can be used to efficiently parse single documents as well as new documents, and compare such documents against older schemas. As new document fragments are validated by the illustrative methods described herein, the newly validated document fragments are stored so that they may be used to compare against additional document fragments parsed from the same or other target documents.

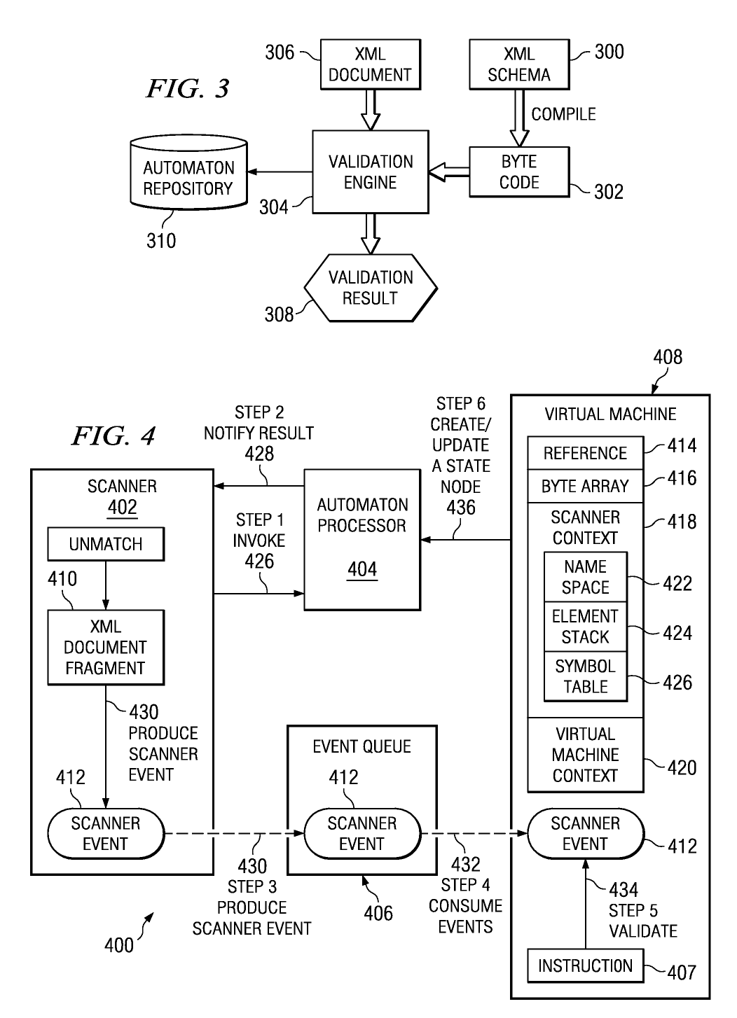

FIG. 3 is a block diagram illustrating an overview of a validation mechanism for validating a structured language document in an illustrative embodiment. The validation mechanism shown in FIG. 3 can be implemented in a data processing system, such as data processing system 100 in FIG. 1 or data processing system 200 in FIG. 2. The block diagram shown in FIG. 1 illustrates how an XML document can be compared to an XML schema. Although the validation mechanism described with respect to FIG. 3 is described with respect to XML documents, this same mechanism can be used with respect to other structured languages. Examples of other structured languages include RSS, math ML, graph ML, scaleable vector graphics, music XML, and others.

First, a given XML schema 300 is compiled into individual byte code 302. An XML schema is a description of an XML document typically expressed in the terms of constraints and structures of contents of documents of that type. The constraints and structures of the documents can be above and beyond the basic constraints and structures imposed by XML itself. Byte code 302 contains a collection of instructions. Validation engine 304 interprets these instructions one by one by parsing XML document 306. Because an instruction validates a subject part of XML document 306, the validation can succeed only when all invoked instructions have succeeded.

The output of validation engine 304 is validation result 308. Validation result 308 usually takes the form of an indication that the target part of XML document 306 is valid, or that the target part of XML document 306 is invalid. Assuming that the target part of XML document 306 is valid, then that part of the document is stored in automaton repository 310.

As additional parts of XML document 306 are compared to and validated against instructions in byte code 302 using validation engine 304, these additional validated parts of XML document 306 are stored in automaton repository 310. Thus, automaton repository 310 contains or stores one or more portions of XML document 306 which have previously been validated. These validated portions of XML document 306 can then be used when validating other portions of XML document 306 and also when validating other XML documents.

FIG. 4 is a block diagram of an exemplary validation engine in accordance with an illustrative embodiment. Exemplary validation engine shown in FIG. 4 can be implemented in a data processing system, such as data processing system 100 in FIG. 1 or data processing system 200 in FIG. 2. In an illustrative embodiment validation engine 400 shown in FIG. 4 can be validation engine 304 in FIG. 3. Although the validation mechanism described with respect to FIG. 3 is described with respect to XML documents, this same mechanism can be used with respect to other structured languages. Examples of other structured languages include RSS, math ML, graph ML, scaleable vector graphics, music XML, and others.

Exemplary validation engine 400 shown in FIG. 4 includes four major components including scanner 402, automaton processor 404, event queue 406, and virtual machine 408. Virtual machine 408 is responsible for executing instructions in byte code. Virtual machine 408 invokes scanner 402, which scans incoming documents to identify XML constructs, such as begin tags and end tags. Attributes of begin tags and end tags are text nodes. The result of scanning is represented as a sequence of events that are consumed by virtual machine 408.

In an illustrative example, scanner 402 first invokes automaton processor 404. Each automaton node corresponds to a begin tag, an end tag, an empty tag where a text node of the XML documents have been processed, or some other tag or component of the XML document. The XML document can be XML document 306 in FIG. 3. Each node contains part of the byte array in past XML documents, so as to perform pattern matching with new incoming documents. Each node also contains a reference to an instruction in the byte codes.

Therefore, when processing new XML documents an automaton can be traversed by automaton processor 404 by performing pattern matching. During pattern matching, execution of some of the instructions can be skipped. Thus, validation engine 400 shown in FIG. 4 is a means for processing partially unmatched parts of XML documents. Because some instructions can be skipped, the validation engine 400 can contribute to the performance enhancement of the XML schema validation process.

In an illustrative example, when a new document is processed, an automaton is constructed. First, scanner 402 parses an XML document and checks the well-formedness of resulting XML fragments in order to produce scanner event 412. Scanner event 412 is a data structure that represents XML document fragment 410, which is a portion of the XML document. Scanner events 412 can include the start tag, text content, end tag, a white space, and other portions of an XML document. Subsequently, scanner event 412 is stored in event queue 406 as shown in FIG. 4.

Thus, event queue 406 includes one or more scanner events 412 generated by scanner 402. Virtual machine 408 receives scanner event 412 from event queue 406. Event queue 406 can transmit scanner events 412 to virtual machine 408, or virtual machine 408 can fetch scanner event 412 from event queue 406. In either case, the term transmitted can be used to describe transferring scanner event 412 to virtual machine 408.

Virtual machine 408 performs validation by executing instruction 407 of an XML schema over scanner event 412. This process repeats until all scanner events are consumed by virtual machine 408. This process may involve reconfiguring scanner 402 so that scanner 402 can optimally process subsequent content.

After validating XML fragment 410 using instruction 407, virtual machine 408 requests automaton processor 404 to create a new state node. Additionally, virtual machine 408 passes four objects through automaton processor 404. These objects include reference 414, which is a reference to the associated instruction in the byte code, byte array 416, scanner context 418, and virtual machine context 420. Reference 414 is stored by partial validation for later usage. Byte array 416 represents the XML fragment at the byte level, with which the automaton processor will compare the XML fragment 410 with contents it has previously parsed. Scanner context 418 is used later in the process of virtual machine 400 so that scanner 402 can start parsing from the intermediate point. Scanner context 418 includes a number of elements such as, but not limited to name space 422, element stack 424, and symbol table 426. Additionally, virtual machine context 420 is an object that enables virtual machine 408 to validate a corresponding portion of the subsequent XML document fragment.

Although operation of validation engine 400 shown in FIG. 4 is described with reference to an XML document and an XML schema, validation engine 400 shown in FIG. 4 can be used with any type of structured language document and corresponding schemas. Thus, generally speaking, the virtual machine shown in FIG. 4 can take the following steps with regard to any structured language document. Step 1 426 is for scanner 402 to invoke automaton processor 404. In step 2 428, automaton processor 404 notifies scanner 402 of the results. Scanner 402 then produces a scanner event 412 at step 3 430. Scanner event 412 is then stored in event queue 406. In step 4 432, a virtual machine 408 consumes scanner events 412. In step 5 434, virtual machine 408 validates each of the scanner events 412. In step 6 436, the virtual machine creates or updates a state node for use by automaton processor 404 which traverses the automaton.

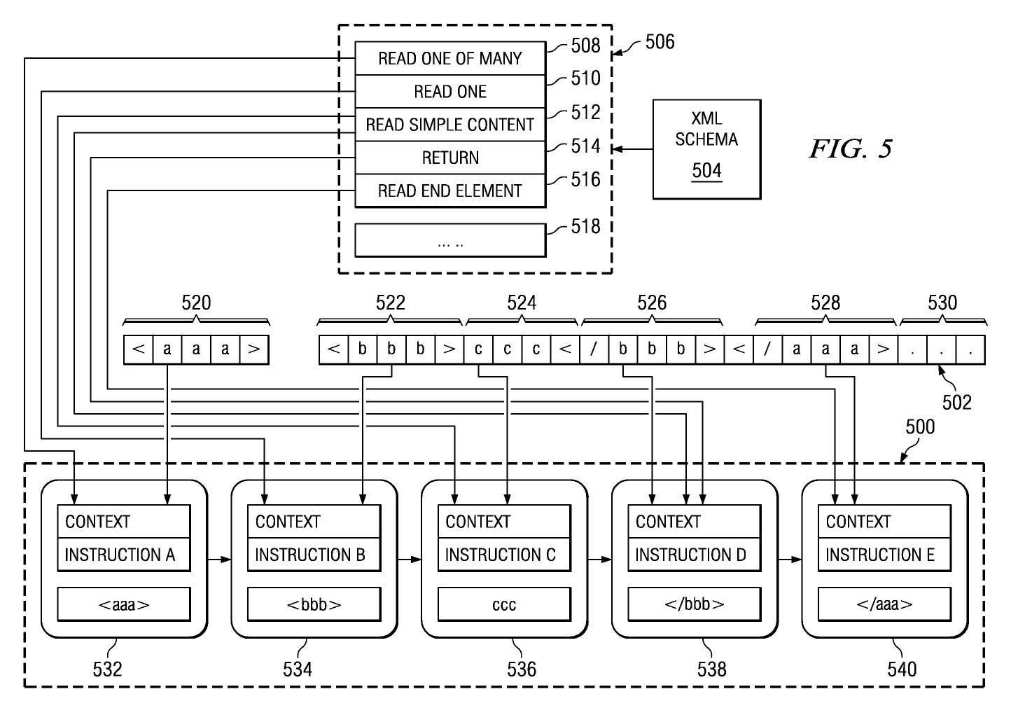

FIG. 5 is a block diagram illustrating an exemplary automaton in accordance with an illustrative embodiment. The block diagram shown in FIG. 5 can be implemented in a data processing system, such as data processing system 100 in FIG. 1 or data processing system 200 in FIG. 2. In particular, the exemplary of automaton shown in FIG. 5 can be constructed in a validation engine, such as validation engine 400, using scanner 402 and automaton processor 404 all shown in FIG. 4.

In the illustrative examples shown in FIG. 5, a process is shown for creating automaton 500 for an XML document 502 starting from “<aaa><bbb>ccc</bbb></aaa>”. In the illustrative examples shown in FIG. 5, XML schema 504 is compiled into a set of instruction codes 506, including READ ONE OF MANY 508, read one 510, read simple content 512, return 514, and read end element 516. However, other instruction codes can be included in the set of instruction codes as indicated by instruction code block 518.

These instruction codes are validated against XML document fragments including <aaa> 520, <bbb> 522, ccc 524, </bbb> 526, </aaa> 528, and possibly other document fragments as indicated by ellipses 530. In the illustrative examples shown in FIG. 5, READ ONE OF MANY instruction 508 is first invoked to partially validate XML fragment <aaa> 520. After the virtual machine successfully executes READ ONE OF MANY instruction 508, the automaton processor creates a corresponding state node with all necessary and desired objects. For example, the automaton processor creates state node 532 from READ ONE OF MANY instruction 508 and document fragment <aaa> 520 together. In the same way, the automaton processor subsequently creates a state node for each of document fragments <bbb> 522, ccc 524, </bbb> 526, and </aaa> 528. The corresponding state nodes are, in order, state node 534, state node 536, state node 538, and state node 540. Together, the set of nodes 532-540 makeup exemplary automaton 500.

The exemplary automaton 500 represented by nodes 532-540 can be used by a virtual machine, such as that shown in FIG. 4. Each of nodes 532-540 is an automaton state that has all the information desired for conducting partial schema validation at any given point. Such information is stored in the context of the state. The context may include information about element hierarchy, namespace bindings, and similar information. For example, node 536 has a stack onto which <aaa> and <bbb> are pushed. The context also contains instructions, such as INSTRUCTION A, INSTRUCTION B, etc . . . , as shown in FIG. 5.

As shown in FIG. 5, INSTRUCTION A corresponds to the “READ ONE OF MANY” instruction 508 in the bytecode, INSTRUCTION B corresponds to “READ ONE” instruction 510, INSTRUCTION C corresponds to “READ SIMPLE CONTENT” instruction 512, INSTRUCTION D corresponds to “RETURN” instruction 514, and INSTRUCTION E corresponds to “READ END ELEMENT” instruction 516.

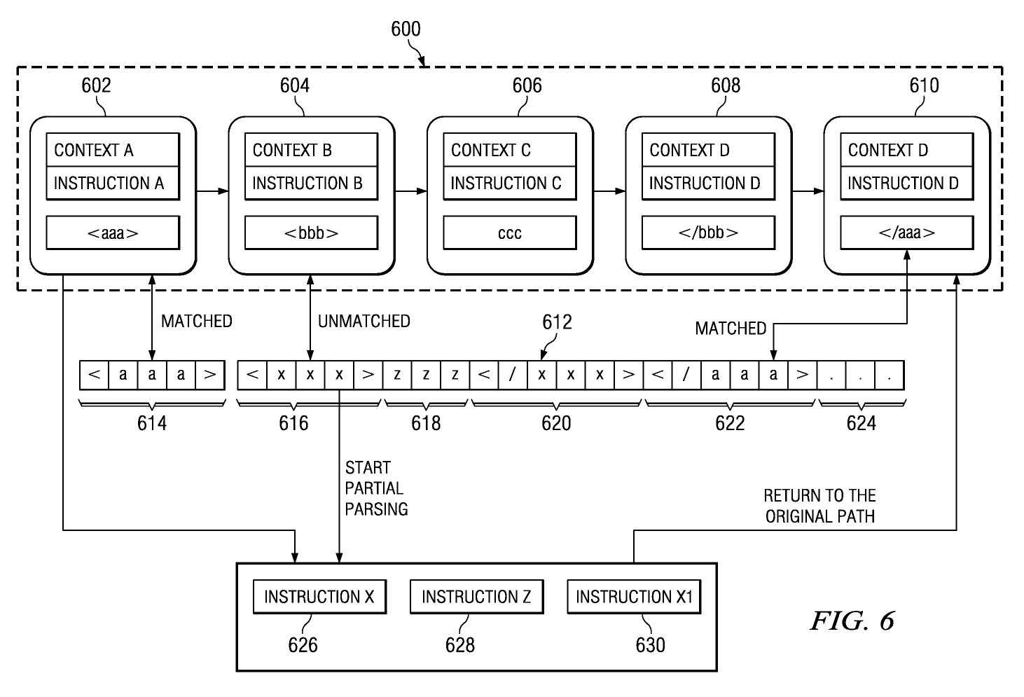

FIG. 6 is a block diagram illustrating processing of a new structured language document using an automaton in accordance with an illustrative embodiment. The process shown in FIG. 6 can be implemented in a data processing system, such as data processing 100 in FIG. 1 or data processing system 200 in FIG. 2. In particular the process shown in FIG. 6 can be implemented using an automaton processor, such as automaton processor 404 in FIG. 4. Although the description of the process in FIG. 6 is described with respect to an XML document, the process shown in FIG. 6 can be used with respect to any structured language document and structured language schema.

In particular, the process shown in FIG. 6 illustrates how automaton 600, which can be automaton 500 generated in FIG. 5, can be used for processing a new document. Thus, node 602 corresponds to node 532 in FIG. 5; node 604 corresponds to node 534 in FIG. 5; node 606 corresponds to node 536 in FIG. 5; node 608 corresponds to node 538 in FIG. 5; and node 610 corresponds to node 540 in FIG. 5. Moreover, similar structures shown in each of nodes 602-610 correspond to similar structures shown in nodes 532-540 in FIG. 5.

In the illustrative examples shown in FIG. 6, a second XML document 612 is received starting from “<aaa><xxx>xxx</xxx></aaa>”. Thus, second XML document 612 shown in FIG. 6 is similar to, but not exactly the same, as XML document 502 shown in FIG. 5. For example, <aaa> 614 is the same as, or is schematically identical to <aaa> 520 shown in FIG. 5. Similarly, </aaa> 622 is the same as, or schematically identical to </aaa> 528 shown in FIG. 5. However, <xxx> 616, zzz 618, and </xxx> 620 do not correspond to any similar structure in FIG. 5. Additional structures can appear in the portion of the XML document shown in FIG. 6 as indicated by ellipses 624.

In the process shown in FIG. 6, the scanner requests the automaton processor to search for any state node matching the incoming byte array. In this example, the scanner successfully finds the state node representing the same byte array <aaa> 614. In the case that the automaton processor finds the matched part of the portion of the XML document fragment in the automaton repository at the second or later parsing, like in this illustrative example, the parser does not either generate a scanner event or store a scanner event to the event queue. Because the virtual machine has no scanner events to be processed, the validation process will be omitted. Even though the validation process is not performed with respect to this portion of the XML document, this portion of the XML document is considered to be validated because only the validation result is represented as a state node in an automaton. Because validation execution cost is relatively high, in terms of the workload a processor must perform to execute the validation, the process shown in FIG. 6 accelerates the overall performance of validation by omitting validation of those portions of XML document 612 that need not be validated.

The next byte array to be processed is <xxx> 616. As the automaton processor cannot find any state representing this byte array, partial parsing will be started by the scanner. In order to partially parse from the intermediate fragment in XML document 612, the scanner loads the scanner context from the previous state representing <aaa> 614. For example, the scanner loads scanner context 418 shown in FIG. 4. Then, the scanner can produce the scanner event and store the scanner event in the event queue, as shown in FIG. 4. The virtual machine fetches the scanner event and attempts to validate the XML fragment represented by <xxx> 616. This partial validation mechanism is realized by loading the instructions in the state node of the automaton, and by loading and setting a context in the virtual machine.

This process is repeated with respect to XML document fragment zzz 618, XML document fragment </xxx> 620, </aaa> 622, and any other XML document fragments 624 that are different from previously validated XML document fragments. In this way, the corresponding instructions, such as instruction X 626, instruction Z 628, and instruction X1 630 are parsed and processed.

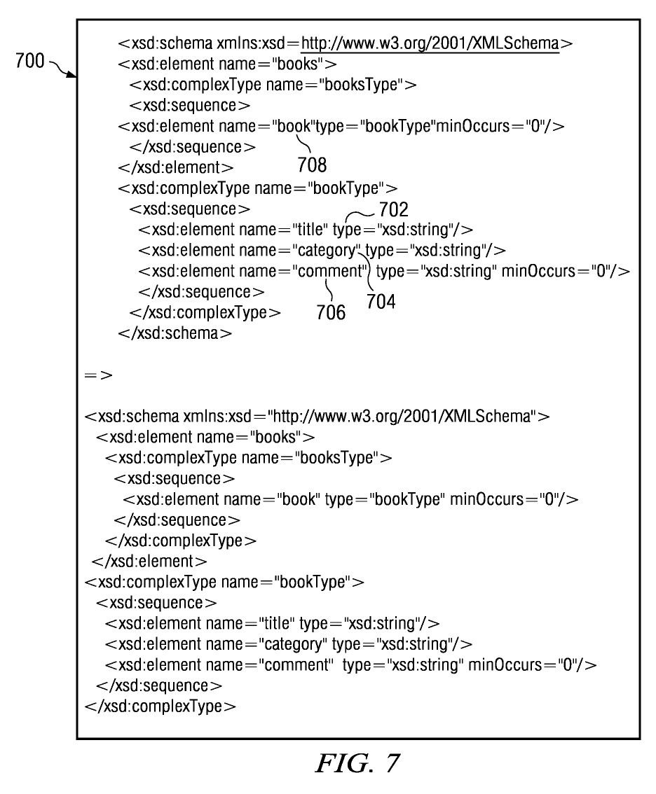

FIG. 7 illustrates an exemplary XML schema in accordance with an illustrative embodiment. XML schema 700 shown in FIG. 7 can be used to validate an XML document, as described further with respect to FIG. 6 through FIG. 9. XML schema 700 shown in FIG. 7 can be used with respect to a virtual machine, such as a virtual machine as described with respect to FIG. 3 and FIG. 4.

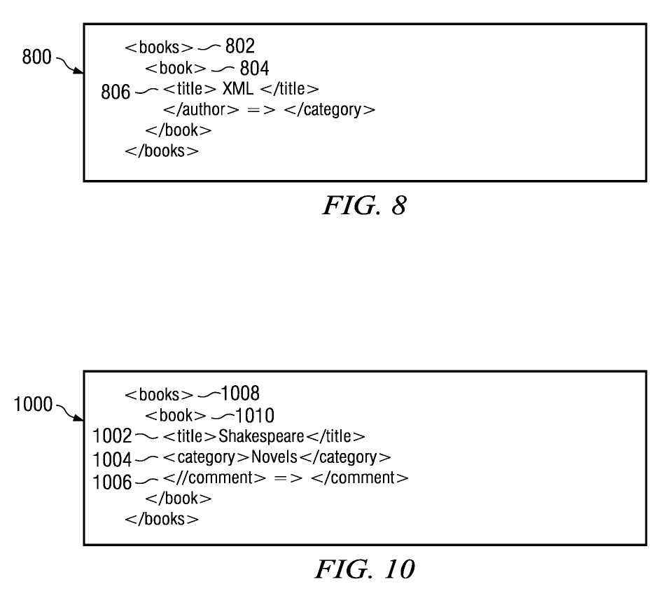

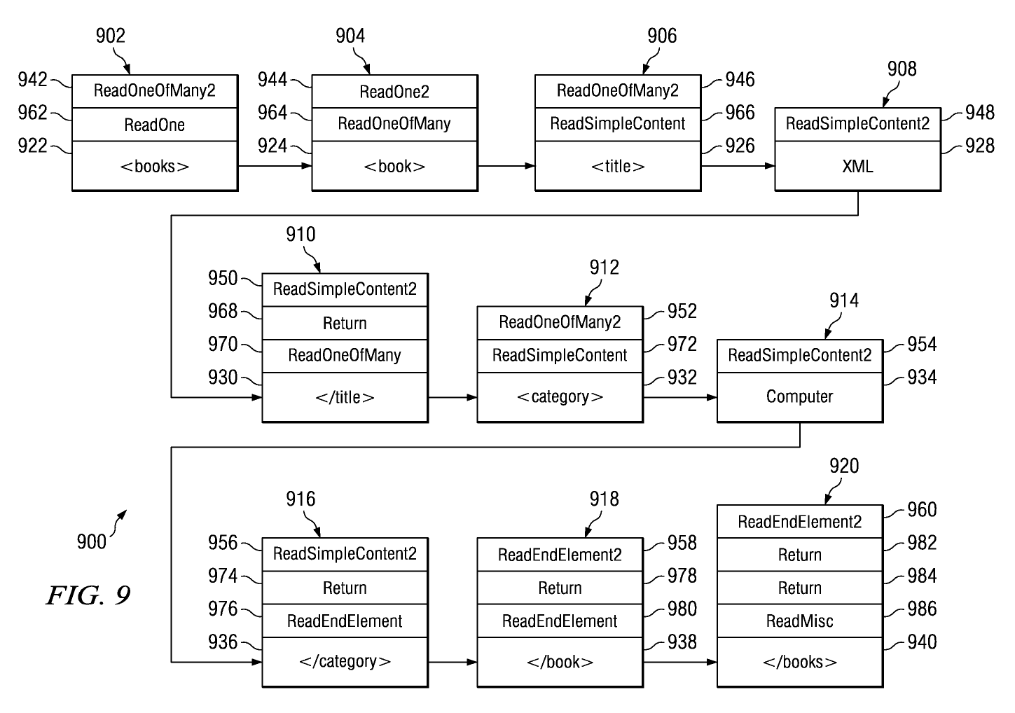

XML schema 700 allows three elements, title 702, category 704, and comment 706 in sequential order under book element 708. Based on XML schema 700 shown in FIG. 7, two different XML instances can be created—as shown in FIGS. 8 and 10. Additionally, FIG. 9 illustrates the entire automaton for XML schema 700 compared against XML document fragment 800 of FIG. 8 after the first parsing.

FIG. 8 illustrates a first XML document fragment to be compared to the XML schema shown in FIG. 7 in accordance with an illustrative embodiment. In the illustrative examples shown, XML document fragment 800 is a first document fragment to be compared to XML schema 700 shown in FIG. 7.

FIG. 9 is a block diagram illustrating an exemplary automaton representing the first XML document fragment shown in FIG. 8 in accordance with an illustrative embodiment. Thus, XML document fragment 800 shown in FIG. 8 is compared to XML schema 700 shown in FIG. 7. Automaton 900 illustrates the entire automaton for XML document fragment 800 shown in FIG. 8 when compared to XML schema 700 shown in FIG. 7, after the first parsing.

Automaton 900 includes a number of state nodes, including state node 902, state node 904, state node 906, state node 908, state node 910, state node 912, state node 914, state node 916, state node 918, and state node 920. Each state node includes one or more input characters that are consumed by that state node. Thus, for example, input characters 922 corresponding to state node 902 are the characters <books>. Input characters 922 are consumed by the corresponding state node 902. Similarly input characters 924 are consumed by state node 904; input characters 926 are consumed by state node 906; input characters 928 are consumed by state node 908; input characters 930 are consumed by state node 910; input characters 932 are consumed by state node 912; input characters 934 are consumed by state node 914; input characters 936 are consumed by state node 916; input characters 938 are consumed by state node 918; and input characters 940 are consumed by state node 920. Additionally, each state node shown in FIG. 9 includes instructions that consume the corresponding input characters. For example, instructions 942 consume input characters 922 in state node 902. Similarly, instructions 944 consume input characters 924 in state node 904. Instructions 946 consume input characters 926 in state node 906. Instructions 948 consume input characters 928 in state node 908. Instructions 950 consume input characters 930 in state node 910. Instructions 952 consume input characters 932 in state node 912. Instructions 954 consume input characters 934 in state node 914. Instructions 956 consume input characters 936 in state node 916. Instructions 958 consume input characters 938 in state node 918. Instructions 960 consume input characters 940 in state node 920.

Additionally, each state node shown in FIG. 9 includes additional instructions that will be executed after the current instruction is executed. The illustrative examples shown in FIG. 9, current instructions correspond to instructions 942, 944, 946, 948, 950, 952, 954, 956, 958, and 960. Thus, for example, instruction 962 in state node 902 will be executed after instruction 942. Similarly, instruction 964 in state node 904 will be executed after instruction 924. Instruction 966 in state node 906 will be executed after instruction 946. Both instructions 968 and 970 in state node 910 are executed after instruction 950. Instruction 972 in state node 912 is executed after instruction 952. Both instructions 974 and 976 in state node 916 are executed after instruction 956. Both instructions 978 and 980 in state node 918 are executed after instruction 958. Finally, instruction 982, instruction 984, and instruction 986 in state node 920 are executed after instruction 960.

The arrows shown in FIG. 9 indicate the order in which each state node is created in the automaton. Thus, each of the statements in XML document fragment 800 shown in FIG. 8 is parsed out into a series of state nodes 902 through 920 in FIG. 9. In this way, automaton 900 is an automaton generated using XML document fragment 800 shown in FIG. 8 when compared to XML schema 700 shown in FIG. 7.

FIG. 10 illustrates a second XML document fragment to be compared to the XML schema shown in FIG. 7 in accordance with an illustrative embodiment. XML document fragment 1000 shown in FIG. 10 represents a fragment of a new XML document to be validated against an XML schema, such as XML schema 700 shown in FIG. 7. XML document fragment 1000 may or may not be from the same document from which document fragment 800 in FIG. 8 is drawn.

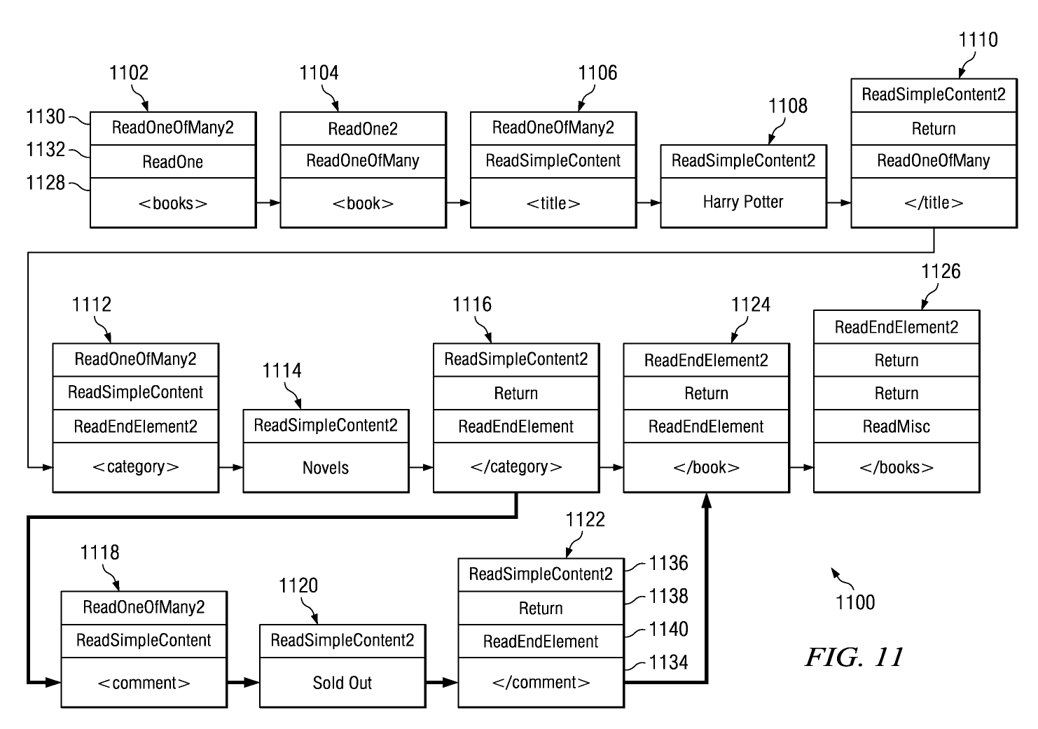

As can be seen, XML document fragment 1000 is similar to XML document fragment 800 shown in FIG. 8, but contains different elements. In particular, XML document fragment 1000 includes particular examples of book title 1002, category 1004, comment 1006, books 1008, and book 1010. XML document fragment 1000 is compared to XML schema 700 shown in FIG. 7 to create automaton 1100 shown in FIG. 11. In this illustrative example, title 1002 is “SHAKESPEARE,” category 1004 is “novels,” and comment 1006 is “sold out.” Thus, the book “SHAKESPEARE” is currently sold out at this particular business. As used herein, the reference to the novel “SHAKESPEARE” is to a novel that is in the public domain.

FIG. 11 is a block diagram illustrating an exemplary automaton representing the second XML document fragment shown in FIG. 10 in accordance with an illustrative embodiment. Automaton 1100 shown in FIG. 11 is created based on a comparison of XML document fragment 1000 shown in FIG. 10 to XML schema 700 shown in FIG. 7. XML document fragment 1000 is an XML document fragment received after XML document fragment 800 of FIG. 8 has already been compared to and validated against XML schema 700 shown in FIG. 7. Automaton 1100 shown in FIG. 11 can be generated using an automaton processor, such as automaton processor 404 shown in FIG. 4.

Because elements books 1008, book 1010, and title 1002 shown in FIG. 10 can be identified as the same as books 802, book 804, and title 806 shown in FIG. 8, the validation process with respect to those elements of XML document fragment 1000 is skipped when creating automaton 1100.

Automaton 1100 is similar to automaton 900 shown in FIG. 9 and has many similar structures. However, automaton 1100 is different than automaton 900 of FIG. 9 in that automaton 1100 includes several state nodes that are unique to document fragment 1000 shown in FIG. 10. Automaton 1100 includes state node 1102, state node 1104, state node 1106, state node 1108, state node 1110, state node 1112, state node 1114, state node 1116, state node 1118, state node 1120, state node 1122, state node 1124, and state node 1126. State nodes 1108, 1114, 1118, 1120, and 1122 are unique to automaton 1100, based on XML document fragment 1000 shown in FIG. 10.

According to the illustrated embodiments described herein, state nodes 1102, 1104, 1106, 1110, 1112, 1116, 1124, and 1126 are schematically identical to corresponding state nodes 902, 904, 906, 910, 912, 916, 918, and 920 in FIG. 9, respectively. Because these state nodes in FIG. 9 have already been validated, validation for corresponding state nodes in FIG. 11 is skipped. Instead, only state nodes 1108, 1114, 1118, 1120, and 1122 are validated. State nodes 1108, 1114, and 1120 do not contain additional instructions, and are thus easily validated as to whether or not they have well-formedness. State nodes 1118 and 1122 are then validated against an XML schema, such as XML schema 700 shown in FIG. 7. Thus, the entire automaton 1100 shown in FIG. 11 can be validated much more efficiently using the illustrative methods compared to if the entire automaton 1100 were validated from scratch.

The state nodes shown in FIG. 11 have structure that is similar to the state nodes shown in FIG. 9. For example, state node 1102 in FIG. 11 includes input characters 1128, instructions 1130 that consume characters 1128 and instructions 1132 that correspond to instructions that will be executed after instructions 1130. Thus, input characters 1128 correspond to input characters 922 in FIG. 9, instruction 1130 corresponds to instruction 942 in FIG. 9, and instruction 1132 corresponds to instruction 962 in FIG. 9. Because state node 1102 contains exactly the same instructions and structure as state node 902 shown in FIG. 9, state node 1102 is said to be schematically identical to state node 902 in FIG. 9.

Similarly, new state nodes shown in FIG. 11 have similar structure to the structure of state nodes shown in FIG. 9. For example, state node 1122 includes input characters 1134, instruction 1136 that consumes input characters 1134, and instructions 1138 and 1140 that are executed after instructions 1136. Other state nodes in automaton 1100 have similar structures.

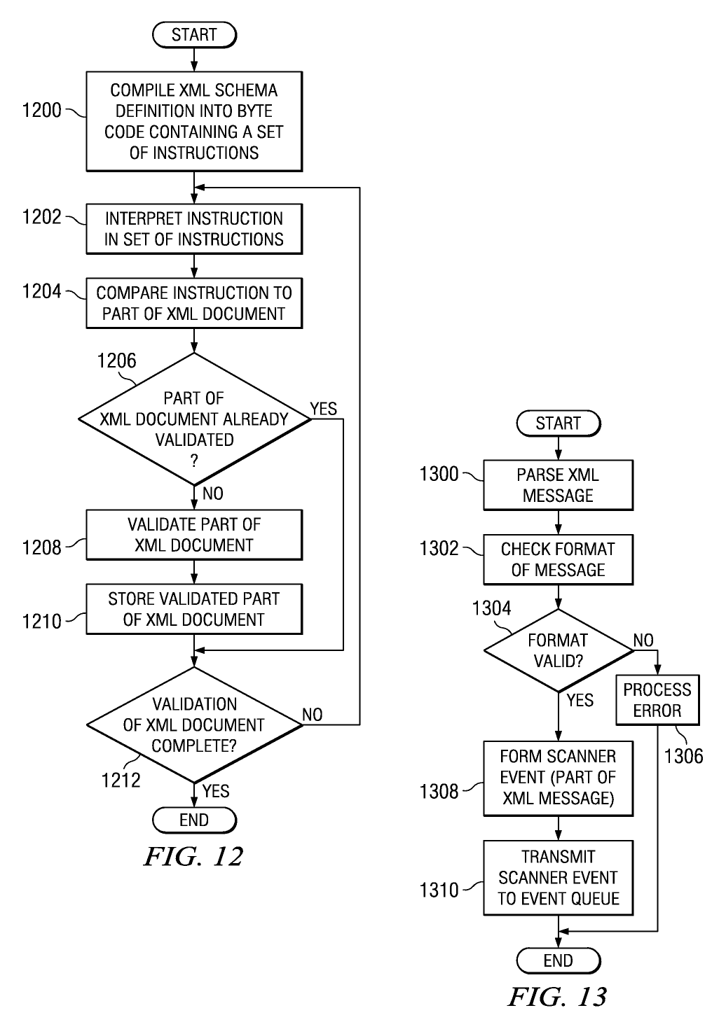

FIG. 12 is a flowchart illustrating an exemplary process for validating an XML document in accordance with an illustrative embodiment. The process shown in FIG. 12 can be executed in a data processing system, such as data processing system 100 shown in FIG. 1 or data processing system 200 shown in FIG. 2. The particular process shown in FIG. 12 can be implemented using a validation engine, such as validation engine 400 shown in FIG. 4.

The process begins as the virtual machine of the validation engine compiles an XML schema definition into byte code containing a set of instructions (step 1200). The virtual machine interprets an instruction in the set of instructions (step 1202). The virtual machine compares the instruction to part of the XML document (step 1204). The virtual machine then determines whether part of the XML document has been validated already (step 1206).

If the part of the XML document has not been validated already (“no” response to step 1206), the virtual machine validates that part of the XML document (step 1208). The virtual machine then stores the validated part of the XML document (step 1210). If the part of the XML document has already been validated (“yes” response to step 1206), then steps 1208 and 1210 are omitted and the virtual machine proceeds directly step 1212. The virtual machine then determines whether validation of the XML document is complete (step 1212). In particular, the virtual machine examines whether or not additional instructions, in the set of instructions, are to be compared to part of the XML document or if there are other parts of the XML document that need to be compared to a particular instruction. In either case, if the validation of the XML document is not complete, then the process returns to step 1202. However, if validation of the XML document is complete, or if that particular part of the XML document has already determined to be valid in (yes to step 1206) and validation of the XML document is complete (yes to step 1212), then the process terminates.

FIG. 13 is a flowchart illustrating operation of a scanner in an exemplary validation engine in accordance with an illustrative embodiment. The process shown in FIG. 13 can be implemented in a data processing system, such as data processing system 100 shown in FIG. 1 or data processing system 200 shown in FIG. 2. The particular process shown in FIG. 13 can be implemented in a validation engine, such as validation engine 400 shown in FIG. 4. Still more particularly, the process shown in FIG. 13 can be implemented in a scanner, such as scanner 402 shown in FIG. 4. As described in FIG. 13, an XML message is an XML document fragment.

The process begins as the scanner parses an XML message (step 1300). The scanner then checks the format of the message (step 1302). The scanner determines whether the format is valid (step 1304). If the process is not valid, then a process error is generated (step 1306) and the process terminates thereafter.

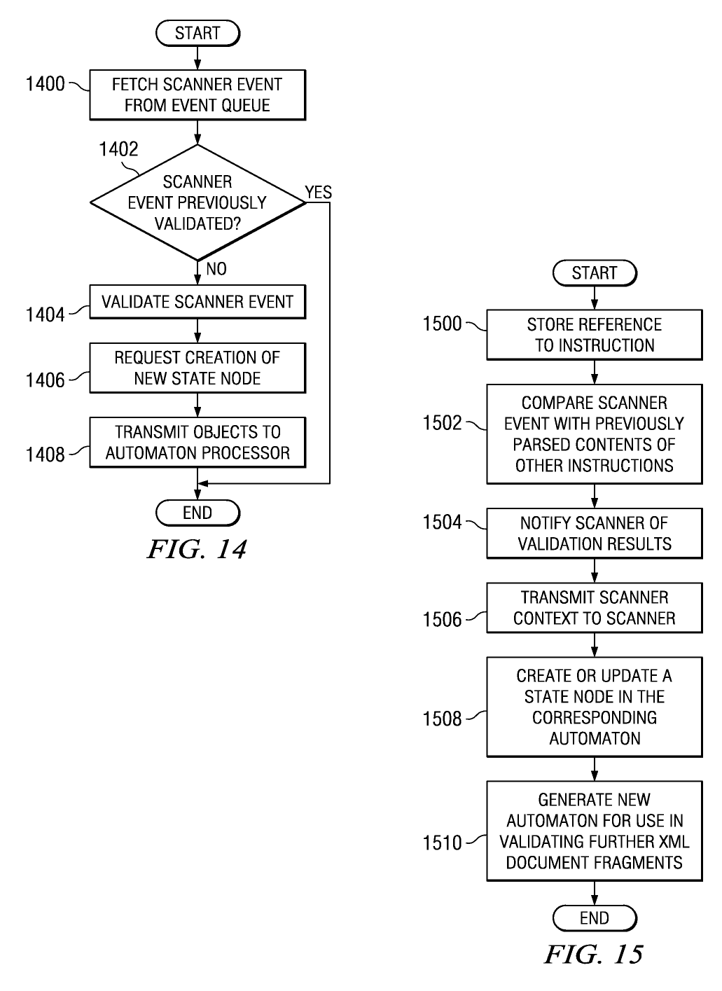

However, if the format of the XML message is valid in step 1304, then the scanner forms a scanner event (step 1308). The scanner event is a part of the XML message described with reference to step 1300. The scanner then transmits the scanner event to an event queue (step 1310), with the process terminating thereafter. Although the process is described as terminating at this point in FIG. 13, the process can continue from step 1310 to the start of FIG. 14 with respect to a virtual machine, such as virtual machine 408 in FIG. 4.

FIG. 14 is a flowchart illustrating an exemplary operation of a virtual machine of a validation engine in accordance with an illustrative embodiment. The process shown in FIG. 14 can be implemented in a data processing system, such as data processing system 100 shown in FIG. 1 or data processing system 200 shown in FIG. 2. The particular process shown in FIG. 14 can be implemented in a validation engine, such as validation engine 400 shown in FIG. 4. Still more particularly, the process shown in FIG. 14 can be implemented by a virtual machine, such as virtual machine 408 shown in FIG. 4.

The process begins as the virtual machine fetches a scanner event from the event queue (step 1400). The virtual machine then determines whether the scanner event has been previously validated (step 1402). If the scanner event has been previously been validated, then the process terminates.

However, if the scanner event has not been validated previously (a “no” response at step 1402), then the virtual machine validates the scanner event (step 1404). The virtual machine then requests creation of a new state node of an automaton (step 1406). The virtual machine then transmits objects to an automaton processor (step 1408), with the process terminating thereafter.

The automaton processor described with respect to step 1408 can be an automaton processor in a validation engine, such as automaton processor 404 of validation engine 400 shown in FIG. 4. The objects transmitted can be any number of objects such as, but not limited to, objects 414, 416, 418, and 420. Each of these objects can include sub-objects. For example, a scanner context object, such as scanner context object 418 shown in FIG. 4, can include sub-objects including name space 422, element stack 424, and symbol table 426, all shown in FIG. 4.

FIG. 15 is a flowchart illustrating an exemplary operation of an automaton processor of a validation engine in accordance with an illustrative embodiment. The process shown in FIG. 15 can be implemented in a data processing system, such as data processing system 100 shown in FIG. 1 or data processing system 200 shown in FIG. 2. In particular, the process shown in FIG. 15 can be implemented in a validation engine, such as validation engine 400 shown in FIG. 4. Additionally, the process shown in FIG. 15 illustrates an overview of the process of the illustrated embodiments described herein.

The process begins as the virtual machine stores a reference to an instruction (step 1500). The virtual machine then compares a scanner event with previously parsed contents of other instructions (step 1502). In this way, the virtual machine validates the scanner event. The virtual machine then notifies the scanner of the validation results (step 1504). Finally, the virtual machine transmits scanner context to the scanner (step 1506). The virtual machine also creates or updates a state node in the corresponding automaton (step 1508). The automaton processor then generates a new automaton for use in validating further XML document fragments (step 1510). The process terminates thereafter.

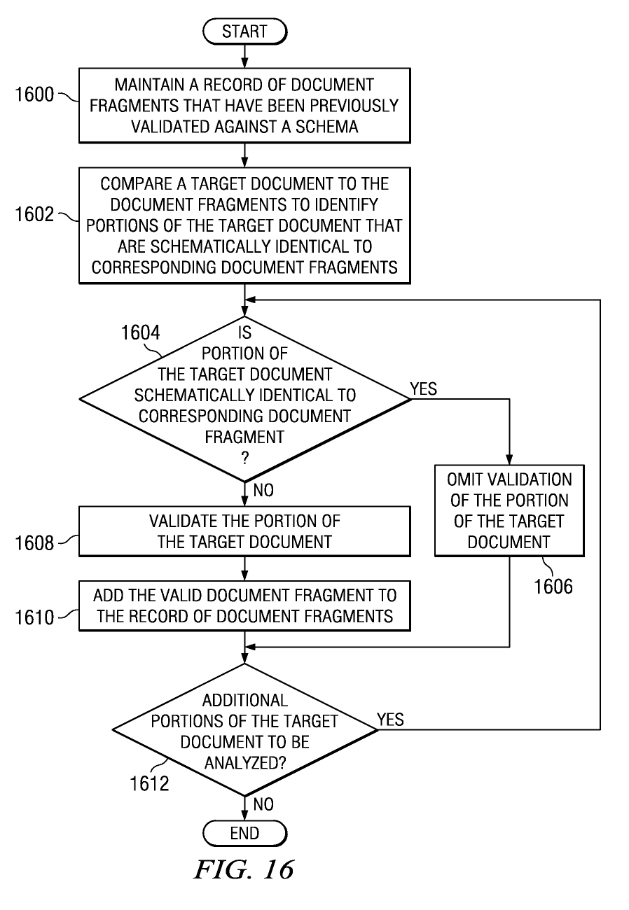

FIG. 16 is a flowchart illustrating an exemplary method of partial validation of a target document in accordance with an illustrative embodiment. The process shown in FIG. 16 can be implemented in a data processing system, such as data processing system 100 shown in FIG. 1 or data processing system 200 shown in FIG. 2. In particular, the process shown in FIG. 16 can be implemented in a validation engine, such as validation engine 400 shown in FIG. 4. Additionally, the process shown in FIG. 16 illustrates an overview of the process of the illustrated embodiments described herein.

The process begins as the validation engine maintains a record of document fragments that have been previously validated against a schema (step 1600). The validation engine then compares a target document to the document fragments to identify portions of the target document that are schematically identical to corresponding document fragments (step 1602). The validation engine then determines whether a portion of the target document is schematically identical to corresponding to the corresponding document fragment (step 1604). If the portion of the target document is schematically identical to a corresponding document fragment, then validation of the portion of the target document is omitted (step 1606), and skips to step 1612. However, if a portion of the target document is not schematically identical to corresponding to a corresponding document fragment, then the validation engine validates that portion of the target document (step 1608). The validation engine then adds the valid document fragment to the record of document fragments (step 1610). The validation engine then determines whether additional portions of the target document are to be analyzed (step 1612). If additional portions of the target document are to be analyzed, then the process returns to step 1604. Otherwise, the process terminates.

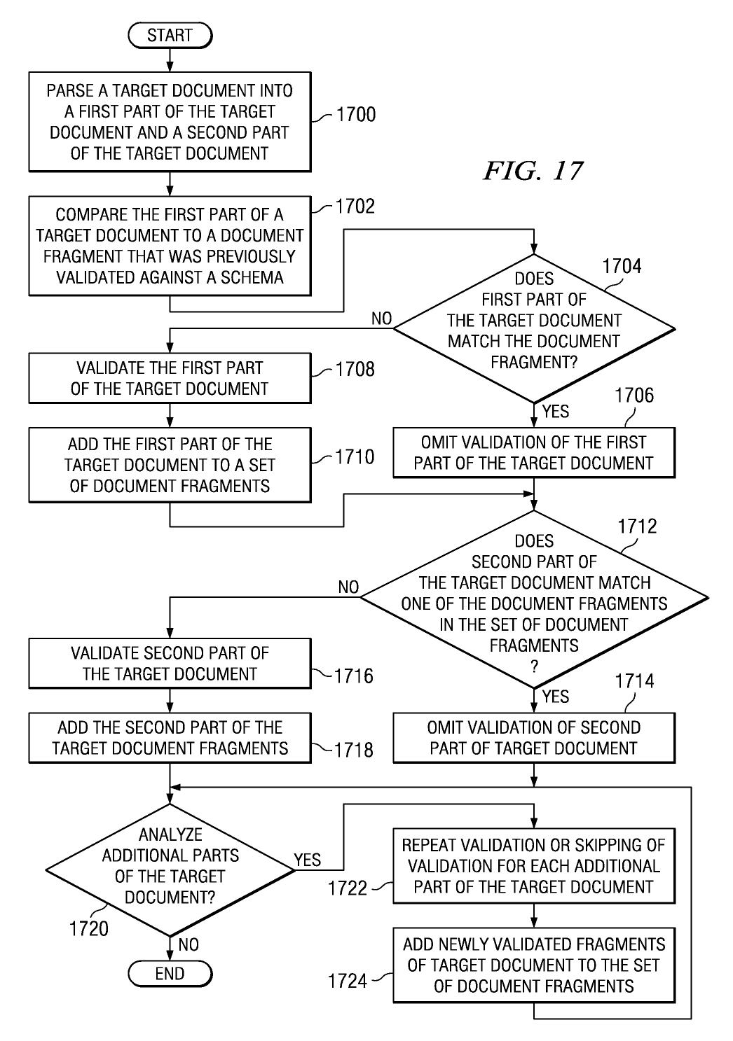

FIG. 17 is a flowchart illustrating an exemplary method of partial validation of a target document in accordance with an illustrative embodiment. The process shown in FIG. 17 can be implemented in a data processing system, such as data processing system 100 shown in FIG. 1 or data processing system 200 shown in FIG. 2. In particular, the process shown in FIG. 17 can be implemented in a validation engine, such as validation engine 400 shown in FIG. 4. Additionally, the process shown in FIG. 17 illustrates an overview of the process of the illustrated embodiments described herein.

The process begins as a validation engine parses a target document into a first part of the target document and a second part of the target document (step 1700). The validation engine then compares the first part of the target document to a document fragment that was previously validated against a schema (step 1702). The validation engine then determines whether the first part of the target document matches the document fragment (step 1704). If the first part of the target document matches the document fragment, then the validation engine will omit the validation of the first part of the target document (step 1706). The process then continues at step 1712. However, if the first part of the target document does not match the document fragment, then the validation engine validates the first part of the target document (step 1708). The validation engine then adds the first part of the target document to a set of document fragments (step 1710).

The validation engine then determines whether a second part of the target document matches one of the document fragments in the set of document fragments (step 1712). If the second part of the target document does match one of the document fragments in the set of document fragments, then the validation engine omits validation of the second part of the target document (step 1714). The process will then continue with step 1720. However, if the second part of the target document does not match one of the document fragments in the set of document fragments, then the validation engine will validate the second part of the target document (step 1716). The validation will then add the second part of the target document to the set of document fragments (step 1718).

The validation engine then determines whether additional parts of the target documents are to be analyzed (step 1720). If additional parts of the target document are to be analyzed, then the validation engine repeats validation or skipping of validation for each additional part of the target document (step 1722). During this process, the validation engine will validate those additional parts of the target document that have not already been validated. The validation engine will skip validation of those additional parts of the target document that match one or more document fragments in the set of document fragments. For each document fragment that the validation engine does validate, the validation engine will add those additional new parts of the target document to the set of document fragments (step 1724). The process then returns to step 1720. If no additional parts of the target document are to be analyzed at step 1720, then the process terminates.

Thus, the illustrative embodiments described herein provide for a method, apparatus and computer usable program product for validating XML documents against an XML schema. However, the methods and devices described herein can be applied to other schema languages and other structured language documents. Thus, the illustrative embodiments described herein provide a mechanism for increasing the efficiency and speed of validating target XML documents against an XML schema. More generally, the illustrative embodiments described herein provide a mechanism for quickly and efficiently validating documents written in a structured language against a structured language schema. The illustrative embodiments described herein create a faster mechanism for validating structured language documents because those portions of a particular structure language document that have already been validated do not have to be further validated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for validating a target document written in a structured language against a schema for the structured language, the method comprising the computer-implemented steps of:
maintaining a record of document fragments that have been previously validated against the schema;
comparing the target document to the document fragments to identify portions of the target document that are schematically identical to corresponding document fragments; and
omitting validation for at least one of the portions of the target document that are schematically identical to the corresponding document fragments when validating the target document.

2. The method of claim 1, further comprising:
adding to the record of document fragments, after successful validation of the target document, at least one portion of the target document that was not schematically identical to any document fragments in the record of document fragments.

3. A method for validating a target document written in a structured language against a schema for the structured language, the method comprising the computer-implemented steps of:
comparing a first part of the target document to a document fragment, wherein the document fragment was previously validated against the schema; and
responsive to the first part of the target document matching the document fragment, omitting validation of the first part of the target document.

4. The method of claim 3 further comprising:
responsive to the first part of the target document failing to match the document fragment, validating the first part of the target document.

5. The method of claim 3 wherein the target document comprises a plurality of additional document fragments, wherein each of the plurality of additional document fragments were previously validated against the schema, and wherein the method further comprises:
responsive to the first part of the target document matching any of the plurality of additional document fragments, omitting validation of the first part of the target document; and
responsive to the first part of the target document failing to match both the document fragment and all of the plurality of additional document fragments, validating the first part of the target document.

6. The method of claim 3 wherein the first part of the target document comprises less than all of the target document.

7. The method of claim 3 wherein the document fragment is a second part of the target document.

8. The method of claim 7 further comprising:
generating the document fragment by successfully validating the second part of the target document against the schema and then storing the second part of the target document as the document fragment.

9. The method of claim 3 further comprising:
parsing the target document into the first part of the target document, wherein the first part of the target document is a scanner event; and
transmitting the scanner event to an event queue.

10. The method of claim 9 wherein the scanner event comprises at least one of a start tag, a text content, a white space, and an end tag.

11. The method of claim 9 further comprising:
transmitting the scanner event to a virtual machine; and
performing a comparison in the virtual machine.

12. The method of claim 11 further comprising:
requesting an automaton processor to create a new state node; and
transmitting at least one object to the automaton processor.

13. The method of claim 12 wherein the at least object is selected from the group consisting of a reference to an associated instruction in a byte code, a byte array, a scanner context, and a virtual machine context.

14. The method of claim 13 wherein the scanner context comprises at least one of a namespace, an element stack, and a symbol table.

15. The method of claim 13 wherein the virtual machine context enables the virtual machine to validate a corresponding portion of a subsequent part of the target document.

16. The method of claim 13 wherein the target document comprises an extensible markup language document and wherein the schema comprises an extensible markup language schema.

17. A computer program product comprising:
a computer usable medium having computer usable program code for validating a target document written in a structured language against a schema for the structured language, wherein the computer program product includes:
computer usable program code for comparing a first part of the target document to a document fragment, wherein the document fragment was previously validated against the schema; and
computer usable program code for, responsive to the first part of the target document matching the document fragment, omitting validation of the first part of the target document.

18. The computer program product of claim 17 wherein the document fragment is a second part of the target document and wherein the computer program product further comprises:
computer usable program code for generating the document fragment by successfully validating the second part of the target document against the schema and then storing the second part of the target document as the document fragment.

19. A data processing system comprising:
a bus;
a memory coupled to the bus, the memory containing a set of instructions for validating a target document written in a structured language against a schema for the structured language;
a processor coupled to the bus, wherein the processor executes the set of instructions to:
compare a first part of the target document to a document fragment, wherein the document fragment was previously validated against the schema; and
responsive to the first part of the target document matching the document fragment, omit validation of the first part of the target document.

20. The data processing system of claim 19 wherein the document fragment is a second part of the target document and wherein the processor further executes the set of instructions to:
generate the document fragment by successfully validating the second part of the target document against the schema and then storing the second part of the target document as the document fragment.
